(19) United States
(12) Patent Application Publication
(10) Pub. No.: US 2019/0224787 A1
(43) Pub. Date: Jul. 25, 2019

(54) ATOMIC BARREL PROCESS

(71) Applicant: Dustin L. Humbert, Hubbard, OR (US)

(72) Inventor: Dustin L. Humbert, Hubbard, OR (US)

(21) Appl. No.: 16/253,383

(22) Filed: Jan. 22, 2019

Related U.S. Application Data
(60) Provisional application No. 62/619,858, filed on Jan. 21, 2018.

(51) Int. Cl. B23P 11/02; F41A 21/04

(52) U.S. Cl. CPC B23P 11/025; F41A 21/04

(57) ABSTRACT

A method for manufacturing a rifle barrel is provided. The method is attained by providing an inner barrel defining a rifle bore, and having an outside diameter of a selected first amount at room temperature. Further, by providing an outer sleeve defining a bore, and having a second diameter at room temperature less than the first amount. The outer sleeve is heated to a temperature above room temperature, and the inner barrel is inserted into the bore of the sleeve.

### CROSS-REFERENCE TO RELATED APPLICATIONS

This application claims the benefit of U.S. Provisional Patent Application No. 62/619,858 filed on Jan. 21, 2018, entitled “Synergy Atomic Barrel Process”, which is hereby incorporated by reference in its entirety for all that is taught and disclosed therein.

### FIELD OF THE INVENTION

The present invention relates to a method for manufacturing a rifle barrel, and more particularly to a process that creates a more accurate, durable, rigid, and stable barrel.

### SUMMARY OF THE INVENTION

This barrel process invention has several benefits, which include: Lighter in weight, the Barrel is made out of Titanium and Stainless Steel. Titanium is a light weight metal making this barrel.

Better Accuracy: Because of the design, process and materials used, it creates a better/stronger, more rigid, better stability, and more durable, which all make for a more accurate barrel.

Greater Thermal Conductivity: Because Titanium cools at a much faster rate than stainless steel, the Titanium draws the heat out of internal stainless-steel portion of the barrel.

Withstands higher levels of heat and higher temperature operations better than other barrels, which adds to the stability.

Less harmonic noise, which creates less wear on the barrel, better for accuracy and an overall greater life span of the barrel.

### BRIEF DESCRIPTION OF THE DRAWINGS

FIG. 1 is a sectional view of the of the current embodiment showing the assembled Synergy Barrel.

FIG. 2 is a perspective view of the preferred embodiment showing the outer completed view of the barrel.

FIG. 3 is a perspective view of the preferred embodiment showing the Internal Barrel Core.

FIG. 4 is a sectional view of the preferred embodiment showing the External Outer Barrel Contour.

### DESCRIPTION OF THE CURRENT EMBODIMENT

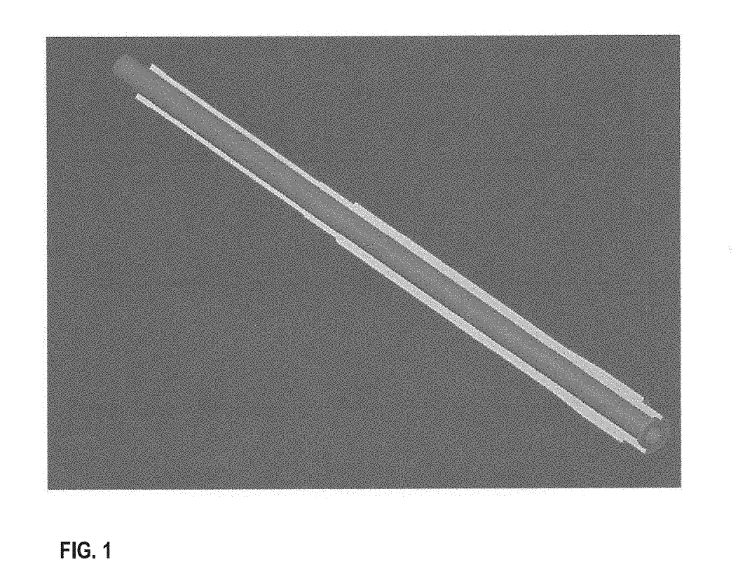

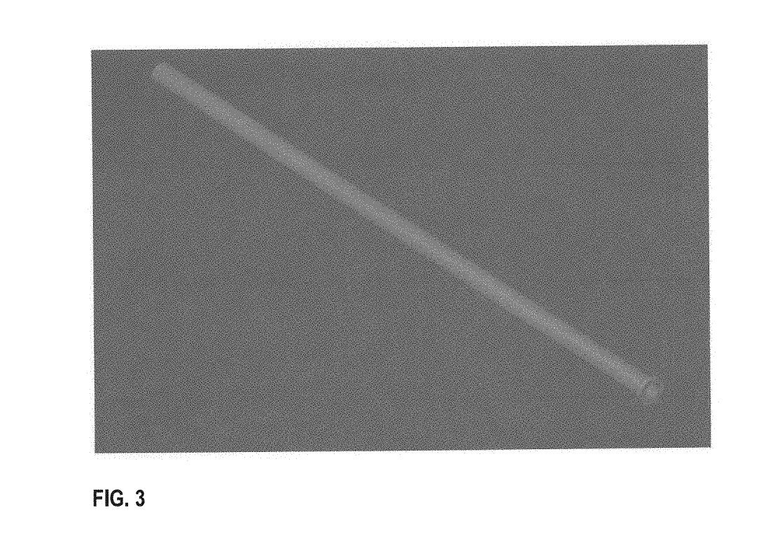

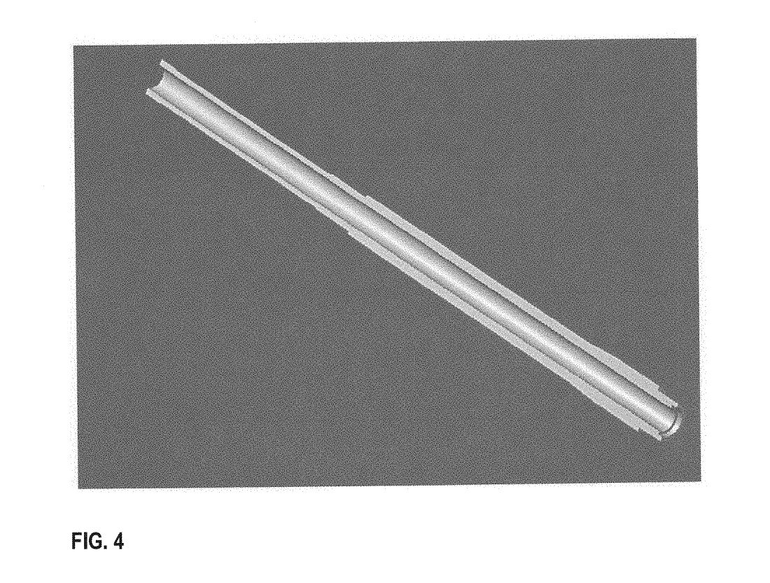

FIG. 1 shows the assembled Synergy Barrel (Cut away view of assembled barrel). The Assembled barrel of both FIG. 3 (Internal Barrel Core) and FIG. 4 (External Outer Barrel Contour Portion) is shown as cut in half to view the two pieces placed together. These two parts and two metals, thermally assembled, become one complete gun barrel that initially utilize two separate metals to do so. At this point the two have been thermally fit and bonded and have become one piece, making the gun barrel complete.

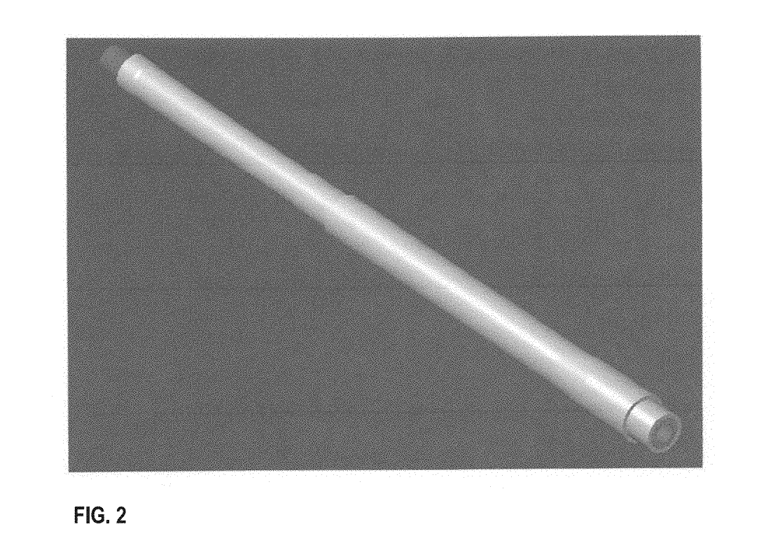

FIG. 2 is a non-cutaway view of FIG. 1, it illustrates an external view of the assembled barrel. This figure has not been cut away showing the outer completed view of the barrel. The Internal Core and the External Outer Barrel Contour have been assembled together making the complete gun barrel. The two metals and parts are thermally assembled and act as one complete functioning Gun-Barrel.

FIG. 3 shows the Internal Barrel Core which is made from Stainless Steel, 416R and 17-4 but not limited to 416R and 17-4. Applications include custom powder metals for high temp applications. This shows the stainless-steel inner core barrel portion without the outer contour portion before it is thermally assembled. This portion is where the bullet passes through.

Internal Barrel Portion is known to be the rifled section, with a desired twist rate and rifling to spin the bullet as the bullet travels through the center of the core.

The outside of the core has a specific interface size 0.001-0.002 larger than that of the bore of the mating of the External Outer Barrel Contour Portion (FIG. 4).

It provides the proper applications on each end. At the entrance side or “beginning” of the barrel it will be chambered for the desired round and bullet. The exit end of the barrel will have the proper application for the muzzle device threads, suppressor or whatever application deemed necessary.

FIG. 4 illustrates the External Outer Barrel Contour which is made from High strength Titanium Grade 5 but not limited to grade 5, also known as the Titanium barrel outer shell.

It acts as the outer most part of the assembled barrel providing the shape, strength and rigidity. It holds the Internal Barrel Core with the use of Thermal Dynamics. This is where the two Figures FIGS. 3 and 4, once assembled, become one acting unit.

It provides the ability to interface with a Bolt Action, and/or Barrel Extension via the screw threads on the chamber end.

It sets the Gas Block position for the barrel, via the diameter and gas system length.

This design is specific to all rifled gun barrels.

Alternate Uses and applications include but are not limited to:

Barrel for the following guns: M16, AR-15, M4, Remington 700 glock, All Glocks (glock 17, 17L, 18, 19, 19x, 20, 21, 22, 23, 24, 25, 26, 27, 28, 29, 30, 30sf, 312, 32, 33, 34, 35, 36, 37, 38, 39, 40, 41, 42, 43), Smith & Wesson, 300 Blackout, 338 Chassis, Bolt Guns, Semi Automatic, Rifle, Precision Rifle, Sniper Rifle, Hand gun, Pistol, Fully Automatic.

Barrel can be used for the following caliber sizes:
Calibers ranging from 0.17 through 0.50

Variations Include:
changing the Stainless Steel 416 to Steel 4150, 4140, or Stainless Steel 17-4.
changing the grade of Titanium that is used
changing the process by changing the tapers, changing the bore diameters, or thickness of the titanium.

(Synergy)™—the process of the Stainless-Steel rifle barrel (FIG. 3) is thermally (atomically) joined to Titanium (FIG. 4), where the metals act as one once they are joined together. The design of the internal barrel with the external taper (FIG. 3) is 0.001-0.002 larger on all surfaces than its mate (FIG. 3 & FIG. 4) are thermally assembled through the use of heat, cryogenics and chemicals to be made as one (FIG. 1) for the improved use in rifle barrel manufacturing.

FIG. 4 is manufactured from Titanium with a long bore section. It is made as a mating part to FIG. 3. Each is made to match the shape of the bore section. This is where FIG. 4 squeezes FIG. 3 once at the same temperature. We heat FIG. 4 up to a temperature hot enough to expand and let FIG. 3 be slid inside. The two become one at this point, once the temperature of FIG. 4 cools, the two acclimate and become one.

This unique process is designed to create a more accurate, durable, rigid, and stable barrel and result in an overall lighter weight, better performing and longer lasting barrel. The process involves atomically bonding two metals (stainless steel and titanium) into one (FIG. 1). First, we cut the titanium and stainless into desired lengths for the barrel. We then drill, ream and shape the internal Stainless-Steel barrel (FIG. 3) using a CNC machine and equipment (such as, CNC Lathe and CNC Grind.) The length of this varies depending on the length of barrel that we are making (for example 7.5″, 8.5″, 10.5″, 14″, 16″, 18″, 22″). The diameter of FIG. 3 can change depending on the caliber version. Show in FIG. 3 is a 22 caliber with a 0.5020 diameter. We then take the Titanium and hollow out the center of it (FIG. 4) making it the outer shell. The final section of FIG. 4 is (Rifling Main) bore section with a 0.500 diameter in the long bore hole. After the two pieces have been machined, we then heat the titanium Outer Barrel Contour portion to desired temperatures 800+ degrees to expand and shrink the and allow the insertion of the inner barrel core portion, this making it one piece. As the temperatures cool, they compress (mold) together to become one piece, as shown in FIG. 1. Once this is done the barrel is ready to have external parts added (barrel pin, and extension) for the finishing touches.

The barrel process invention has many benefits. Titanium is a light weight metal which makes for a lighter weight barrel. The design and materials used to make the barrel makes it stronger, more rigid and durable for better stability. Titanium cools at a much faster rate than stainless steel, making the barrel have a greater thermal conductivity. When the bullet passes through the stainless-steel portion of barrel it creates heat, the titanium then draws the heat out of the stainless steel. With these two metals working together the barrel can withstand higher levels of heat and higher temperature operation, this adds to the stability and overall performance of the barrel. The barrel is designed to produce less harmonic noise (then that of just a stainless-steel barrel), in return there is less wear on the barrel and is better for accuracy and creates a greater life span of the barrel.

I claim:

1. A method of manufacturing a rifle barrel comprising:
providing an inner barrel defining a rifle bore and having an outside diameter of a selected first amount at room temperature;
Providing an outer sleeve defining a bore having a second diameter at room temperature less than the first amount;
Heating the outer sleeve to a temperature above room temperature; and
Inserting the inner barrel into the bore of the sleeve.
